(19) United States
(12) Patent Application Publication
(10) Pub. No.: US 2003/0227827 A1
(43) Pub. Date: Dec. 11, 2003

(54) Time-metering intelligent card

(76) Inventors: Luis E. Elizalde, Coahuila (MX); Jorge C. Pichardo, Coahuila (MX); Jaime G. Morton, San Pedro Garza Garcia (MX)

Correspondence Address: Jong H. Lee, KENYON & KENYON, One Broadway, New York, NY, 10004, US

(21) Appl. No.: 10/289,652

(22) Filed: Nov. 7, 2002

(30) Foreign Application Priority Data
Jun. 10, 2002 (MX) PA/A/2002/005732

(51) Int. Cl. G04F 10/00; G04F 8/00

(52) U.S. Cl. 368/109

(57) ABSTRACT

The present invention relates to an intelligent time-metering card for the charging of public street parking, which consists mainly of a real-time clock controlled by a microcontroller, and a memory for storing the time control data, a display that can be luminous to report credit time to the user and inspectors by means of encoded lights. The device can sense violations to its components and includes an expiry time control.

### BACKGROUND OF THE INVENTION

The present invention relates to a device used for controlling time in vehicle parking lots, e.g., on the street, which is capable of metering time by displaying a reading by means of a visual interface, for example, encoded lights of the type known as LEDS.

The parking fee in public lots has been a technological problem throughout the years, due mainly to the fact that the solutions must be cost-effective and considering that the cost per parking hour is relatively low, while the solutions available to this problem are options wherein the initial investment is very high and the recovering of the same is at a long term.

Mechanical systems of coin-operated timers have been used traditionally as time metering devices on the street. The use of this type of parking meters needs a supporting pole that is anchored to the street and on which the device is installed.

This arrangement involves countless problems such as inaccuracy, tampering or fraud vulnerability, the need of continuous maintenance, and further it causes an unpleasant esthetical effect in the city, although there have been attempts for modifying the ornamental arrangement of the supporting pole, there are no solutions to the above mentioned disadvantages and problems.

Generally, the maximum available time for this type of devices is from 1 to 4 hours, charged in 15 minute time stretches, which causes the disadvantage that if a user wishes to park for long periods of time, the user must add coins continuously, generating problems because of the coin availability, time availability and on other hand, the authority has to collect the coins continuously to avoid damage to the mechanical system, thus raising the operating costs. The main limitations of these systems are the high maintenance cost, vandalism and evasion.

One approach to solve the existing problems with traditional parking meters is the use of electronic parking meters such as described in U.S. Pat. No. 6,312,152 B2, U.S. App. US2001/0012241 and U.S. Pat. No. 5,805,083, which describe the use of microprocessors with interfaces to real-time clocks and a semiconductor memory disc of at least 32 k of memory, that can store a plurality of programs that are useful for assigning cost per zone. This new kind of parking meters has a paying form that can be mixed, with coins and/or prepaid cards; this concept is attracting the attention throughout the world.

Electronic parking meter sophistication makes the systems very versatile, inclusive, the possibility of installing video cameras is considered such as described in U.S. Pat. No. 6,209,367. Another example of this versatility are the parking meters described in U.S. Pat. Nos. 6,229,455 B1; 5,642,119 and 5,862,508 which relate to the use of photocells, sonic transducers and radio frequency receivers-transceivers that sense the presence of vehicles, as well of signal transmission to the relevant authority by means of a transceiver with an aim to avoid payment evasion by the parking lot. These parking meters have the disadvantage that the cost is elevated and that they are exposed to vandalism on the streets, and the above-mentioned problems.

Other attempts of finding the ideal system for parking meters are the simple approaches described in U.S. Pat. Nos. 4,240,649; 4,622,256 and 4,241,943 where it is mentioned that through the use of an imprinted cardboard card, the user is invited to check it's arrival and departure times from the parking lot, leaving the control to the user. However, the result of this is not what it is expected, together with the issue that the cards can be easily forged and as a consequence this kind of systems have turned out to be inoperable.

Simple controlling methods are the ones used in tag dispensing machines, which mark the parking lot arrival time and subsequently have to be placed on the vehicle's windshield. However, this system has not been used massively in that dispensing machines are costly and a reasonable amount thereof are required in perimeter determined by the user.

The aspect of employing simple and low cost metering systems led to the publication of U.S. Pat. No. 5,528,563, which describes the use of a porous paper and a colored liquid. When the paper is placed vertically and the liquid is contacted with the paper on its lower part, it ascends by wicking or capillary effect through a porous material preset space, metering time in an indirect manner. This patent does not addresses the problem of temperatures reached in the vehicle's interior during summer, which greatly affect the capillary or wicking balance and the liquid characteristics, thus causing big errors in time metering.

A concept that has been recently introduced un parking meter designing is the use of electronic means such as the ones of U.S. Pat. No. 5,442,600 in which, by means of a single equipment used inside the vehicle, the parking time is intended to be metered. However, this system is of high cost and ambiguous in payment forms.

Lie, Tomer and Chiu, in U.S. Pat. Nos. 4,730,285; 4,717,815 and 5,309,414, have suggested the use of prepaid electronic cards wherein zone and cost per zone can be selected. In spite of being good, this concept gets complicated with the parking zone selection, which causes that the device needs to perform operations that electronically require more powerful microcontrollers and higher costs, thus raising the cost of the device. In U.S. Pat. No. 5,382,780 a similar device is shown, with the difference that a parking zone register base is used, thus elevating even more the product cost.

It is an object of the invention to provide a device with such a design that the above-mentioned problems are solved in its entirety.

Another object of the present invention is to propose a device design with technical improvements according to those suggested in the present invention resulting in a single, portable device, which can be discarded upon the end of its usage cycle.

It is therefore another object of the present invention to provide a device which is capable of metering time in a very accurate manner and in which the time metering quality is not affected by weather aspects, such as the temperature reached in a vehicle's interior when this is exposed to an ambient temperature range of between −15 and 50° C., or also the rain that by wetting the device can oxidize its metallic parts and as a consequence continuous maintenance has to be provided, or its accuracy and precision features are lost.

### BRIEF DESCRIPTION OF THE DRAWINGS

FIG. 1 is a top plant view of a card design.

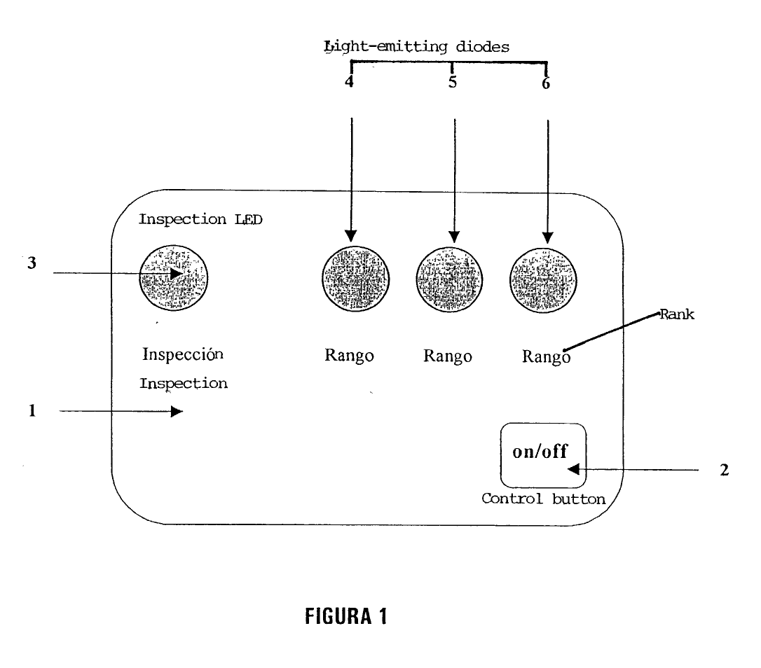

FIG. 2 is an electrical chart of an specific embodiment of card design.

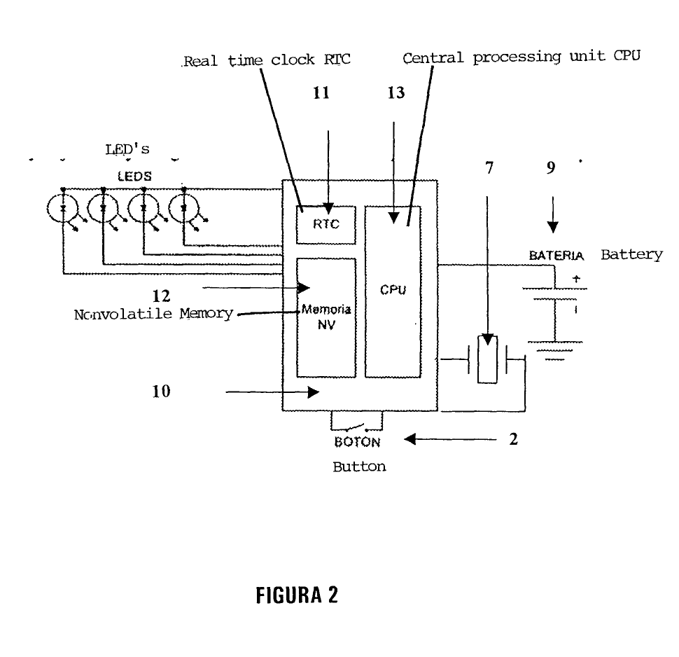

### DETAILED DESCRIPTION OF THE INVENTION

The present invention relates to a card specifically designed for controlling time which in a preferred embodiment consists of a control button (2) to activate the card systems. By depressing the control button (2), a signal is generated from a power supply (9) which sends an electrical pulse to the microcontroller (10) that includes a real-time clock (11) and a crystal oscillator (7) for metering time stretches or segments and reporting them to the process control unit (13), saving this information on memory (12) and reporting it to the user through the light emitting diodes LEDs (4, 5 and 6) whereby one, the other o the third will be enlightened, depending on the situations or the remaining periods of time which have to be reported to the user.

More specifically, the system includes the following operating states.

The first one of them is the initializing state, i.e., when the system is energized for the first time, thus initiating a turn on sequence of all LED's (4, 5, 6) in a serial way with a preset turn on time. With this operation, an specific data sequence is stored on memory (12) for the system to identify that the device has already been initialized. Once in memory (12) if the data sequence is forced to reset, the system will consider this as a violation and consequently will be disabled. The device can be operated by depressing the control button (2) if the test sequence was successful. By depressing this button, the equipment will remain turned off, waiting until button (2) be depressed again to start credit time descent from the value in which it remained before by means of memory (12). Expiry time is a concept defining the card lifetime, because the device, once it has been initialized performs a time metering permanently by comparing this variant with a preset data, that once it has been reached the device will be disabled regardless of the credit time.

The second operating state is that in which by depressing button (2), the central processing unit (13) begins to discount credit time, the remaining time is stored in memory (12), and reports the available time by turning the respective LED (4, 5 or 6) on, namely, each LED (4, 5 or 6) involves a lapse that can be long, medium or minimum depending on the available time. Moreover, the inspecting LED (3) is alternatively enlightened to report that there is still credit time available. Once button (2) is depressed, the countdown begins, discounting credit time and storing the new information in memory. There is also a double memory writing sequence for verifying the correct data storing. This operating mode of the time indicating device enables the user to pay only for the time that remains parked on the street, allowing to reuse the device until its credit time be zero, when the device is disabled and can be discarded. By depressing the button again, the microcontroller will stop discounting credit time and will also stop turning on the LED's, however, will continue to discount expiry time.

This whole operation will continue while the credit time or lifetime are being depleted.

The third operating state consists in credit time identification for establishing if the credit has ended. When the credit value has expired, every time the button is depressed, the time indicating device (1) will display a turning on sequence LED 1, LED 2, LED 3 only once. All LED's (3, 4, 5 and 6) will remain subsequently off until the button is depressed again.

The fourth operating state can be defined as one in which expiry time has been reached, even though the credit time is not over or a re-enlightening violation is detected. At this stage, the device (1) will display a turning on sequence INSPECTION, LED1, LED2, LED3 (3, 4, 5 and 6) only once. The LED's will remain subsequently off until button (2) is depressed again. This operating state has priority over the microcontroller (10), thereby the useful lifetime expired display or violation display has priority over the expired credit display.

### EXAMPLES

20 time control cards were prepared and were energized with lithium three-volt batteries of the CR 2032 type, the turning on sequence was examined and it showed to fulfill the operating state 1, i.e., the initialization began by the sequential enlightening of the LEDs. The system was turned off and the 20 cards were subject to different operating conditions in terms of temperature and humidity, using an oven that kept the cards at temperatures of 85° C. and relative humidity over 85%. It was found that the system operates well at the conditions under which it was exposed because when the cards were pulled out of the oven and of the humidity conditions mentioned above, the system turned on and it was found to comply with the operating state 2.

### NOVELTY OF THE INVENTION

Once the invention has been described, it is considered as novelty and therefore claimed as exclusive use, what is set forth in the appended claims.

1. Intelligent time-metering card characterized by including a control button, a power supply, a real-time clock, an oscillating crystal, a microcontroller with a user-inaccessible memory and light emitting diodes LEDs.

2. Intelligent card as recited in claim 1, wherein it comprises time metering means which include jointly a microcontroller, a real-time clock and a oscillating crystal for metering time stretches or segments.

3. Intelligent card as recited in claim 1, wherein it has a control button for initiating the card systems, by generating a signal from a power supply to the microcontroller, a real-time clock and an oscillating crystal for metering time stretches or segments and reporting them to the process control unit and storing the information on the memory to thereafter report it to the user.

4. Intelligent card as recited in claim 1, wherein it comprises a credit time counting system.

5. Intelligent card as recited in claim 1, wherein it comprises a buffer memory microcontroller.

6. Intelligent card as recited in claim 1, wherein it comprises an inspection system.

7. Intelligent card as recited in claim 1, wherein it has a finite useful lifetime, independent from the prepaid time.

8. Intelligent card as recited in claim 1, wherein the time counting system is disabled upon expiry of the credit time or when a tampering or violation of the device is detected.
